(19) United States
(12) Patent Application Publication
(10) Pub. No.: US 2004/0041070 A1
(43) Pub. Date: Mar. 4, 2004

(54) Flag holder accessory for a receiver assembly

(76) Inventor: Gregory D Richardson, Romulus, MI (US)

Correspondence Address: KING & SCHICKLI, PLLC, 247 NORTH BROADWAY, LEXINGTON, KY, 40507, US

(21) Appl. No.: 10/415,064

(22) PCT Filed: Oct. 2, 2001
(86) PCT No.: PCT/US01/30712

(51) Int. Cl. F16M 13/00

(52) U.S. Cl. 248/511

(57) ABSTRACT

An apparatus (63) is provided for mounting a flag (62) to a receiver assembly (10) on a vehicle. The apparatus (63) includes a pole (60) for receiving and carrying a flag (62). The apparatus (63) also includes a body (63) having a bar (64) for securing the body to the receiver assembly (10) and a mount (66) for receiving and holding the pole (60). Additionally, the apparatus includes a fastener (80) for securing the pole (60) to the mount (66).

This application claims the benefit of U.S. Provisional Patent Application Serial No. 60/243,485 filed Oct. 26, 2000.

### TECHNICAL FIELD

The present invention relates generally to accessories for mounting on receiver assemblies and, more particularly, to a flag holder accessory for mounting on an accessory receiver of a receiver assembly and holding and displaying a flag.

### SUMMARY OF THE INVENTION

It has long been known to construct towing hitches that are mounted to vehicles in order to allow the towing of trailers or the like. In recent years such hitches have been designed to include a receiver box having a rearwardly directed opening or cavity for the receipt of a hitch or draw bar that carries a hitch ball or other means allowing connection to a trailer. Examples of such a structure include the Insta-Hitch II and Custom Hitch Receiver 35365 as manufactured by Reese Products, Inc. of Elkhart, Ind. Such a hitch receiver is also disclosed in, for example, U.S. Pat. No. 3,768,837 to Reese, owned by Reese Products, Inc.

Recent efforts to enhance the versatility of a hitch receiver have led to development of various accessories (e.g., both open and closed article carriers, bike racks, ski racks, tables, winches or other equipment) mounted by means of an accessory mounting bar in the receiver box of a receiver assembly. Because of their convenience and suitability to the particular applications/interests of the user, such accessories have become very popular.

In order to allow for or accommodate trailer towing and accessory mounting simultaneously, a trailer hitch assembly with both a trailer hitch receiver and towing accessory receivers has been recently developed and is the subject of U.S. patent application Ser. No. 60/194,502, filed Apr. 3, 2000. This new trailer hitch receiver assembly includes a central frame member, a mounting bracket carried on each end of the central frame member for securing the central frame member to the vehicle, a hitch receiver box carried on the central frame member and at least one accessory receiver for receiving and holding a recreational and/or utilitarian accessory.

The present invention relates to a flag holder particularly adapted for mounting in a receiver box and/or accessory receiver of a receiver assembly. The flag holder allows the user to fly a selected flag or banner from his vehicle. Such a flag may be utilized to help identify the vehicle from a distance, show allegiance to a particular sports team or cause, display a humanitarian message or for any other useful or desirable purpose.

### SUMMARY OF THE INVENTION

In accordance with the purposes of the present invention as described herein, an apparatus is provided for mounting a flag to a receiver assembly mounted to or carried on a towing vehicle. The apparatus includes a pole for receiving and carrying the flag, a body including a bar for securing the body to the receiver assembly and a mount for receiving and holding the pole, and a fastener for securing the pole to the mount.

More specifically describing the invention, a pair of aligned mounting apertures are provided in the bar for receiving and holding a pin that secures the apparatus to the receiver assembly. Additionally, the mount includes an opening for receiving and holding the flag pole. The proximal end of the pole is received in a socket of a sleeve including a threaded end. The fastener comprises a cooperating lock nut, threadedly received on the threaded end of the sleeve, for clamping the flag pole to the mount. In one possible embodiment of the invention the mount is a flange projecting upwardly from the bar at an included angle with the bar of between substantially 10° to about 70°.

Still other objects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawings incorporated in and forming a part of the specification, illustrate several aspects of the present invention and together with the description serve to explain the principles of the invention. In the drawings:

FIG. 1 is a perspective view showing a receiver assembly to which the apparatus of the present invention may be mounted;

FIGS. 2a-2c are partially cutaway detailed front, right side and rear elevational views of the flag holding apparatus; and

FIG. 3 is a perspective view illustrating the apparatus of FIGS. 2a-2c connected to the receiver assembly.

Reference will now be made in detail to the present preferred embodiment of the invention, an example of which is illustrated in the accompanying drawing.

### DETAILED DESCRIPTION OF THE INVENTION

Reference is now made to the drawing figures showing a receiver assembly, generally designated by reference numeral 10, and the flag holding apparatus of the present invention, generally designated by reference numeral 11.

The receiver assembly 10 includes a central frame member or cross member 12 preferably formed from a pair of tubular steel sections 14 welded to the opposing side walls 16 of a centrally located receiver box 18 so as to project outwardly in opposing directions. The tubular steel sections 14 may be formed with a round cross section as shown in the drawing figures, a square cross section or any other appropriate shape providing the necessary strength to function as a receiver assembly.

The receiver box 18 includes a reinforced lip 20 defining an opening leading to a hitch bar receiving cavity 22. Aligned apertures 24 in the opposing side walls 16 of the receiver box 18 allow the secure connection of a hitch bar in the receiver box in a manner well known in the art by means of a connecting pin and cooperating pin clip (not shown). A chain plate 26 of steel material is welded to the receiver box 18 and tubular steel sections 14 in order to strengthen the connection. As is known in the art, the chain plate 26 includes two apertures 28. The safety chains of a trailer may be connected to the chain plate 26 through engagement in these apertures 28.

Vehicle mounting brackets 30 are mounted adjacent the distal end of each tubular section 14. More specifically, each mounting bracket 30 includes a notch 32 sized and shaped to receive the tubular section 14. The brackets 30 are welded to the tubular sections 14 in order to complete the connection.

The mounting brackets 30 each include a mounting flange 34 and an upwardly projecting mounting lug 36, both with apertures 38. Nut and bolt fasteners (not shown) are extended through these apertures 38 and cooperating apertures drilled in the frame of the towing vehicle in order to mount the receiver assembly 10 thereto.

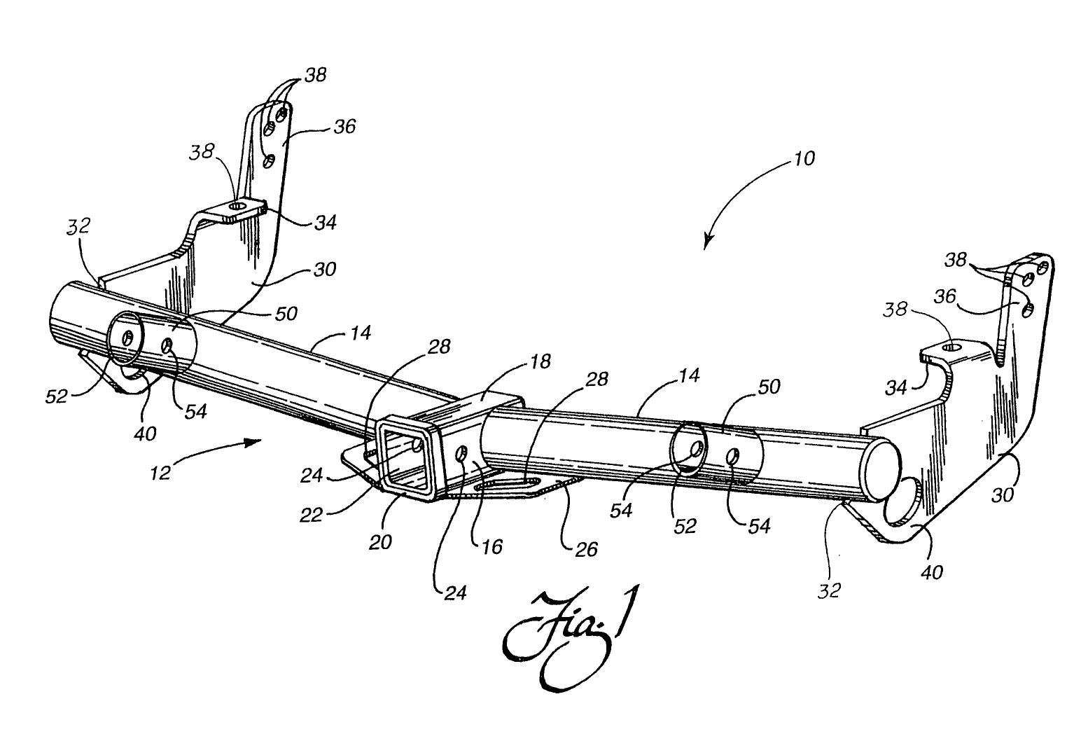

As also shown in FIG. 1, the receiver assembly 10 incorporates a pair of tow hooks or loops 40, one integrally formed in each mounting bracket 30. The tow hooks 40 may be engaged with a tow line such as a rope, chain or cable in order to complete certain towing applications. As also shown, the receiver assembly 10 includes a pair of accessory receivers 50 carried on the tubular sections 14 of the central frame member 12. Each of the accessory receivers 50 is formed from a steel tube that is welded to the section 14 so that one accessory receiver is positioned between the receiver box 18 and each mounting bracket 30.

As shown, each accessory receiver 50 includes a circular port or opening 52 and cooperating aligned apertures 54 in the sidewall thereof to allow secure connection of a trailer hitch accessory by means of a connecting pin and pin clip of a type well known in the art such as utilized to secure the hitch bar in the receiver box 18. Each of the accessory receivers 50 is oriented with respect to the central frame member 12, receiver box 18 and the towing vehicle upon which the assembly 10 is mounted so as to be readily accessible by the towing vehicle operator. More specifically, each falls in a first plane which defines an included angle of between about 10° to about 30° (e.g. 20°) with a second plane which contains the longitudinal axis of the receiver box 18. Thus, the accessory receivers 50 have a port or opening 52 that opens upwardly for better visibility and accessibility that directly leads to easy connection of an accessory.

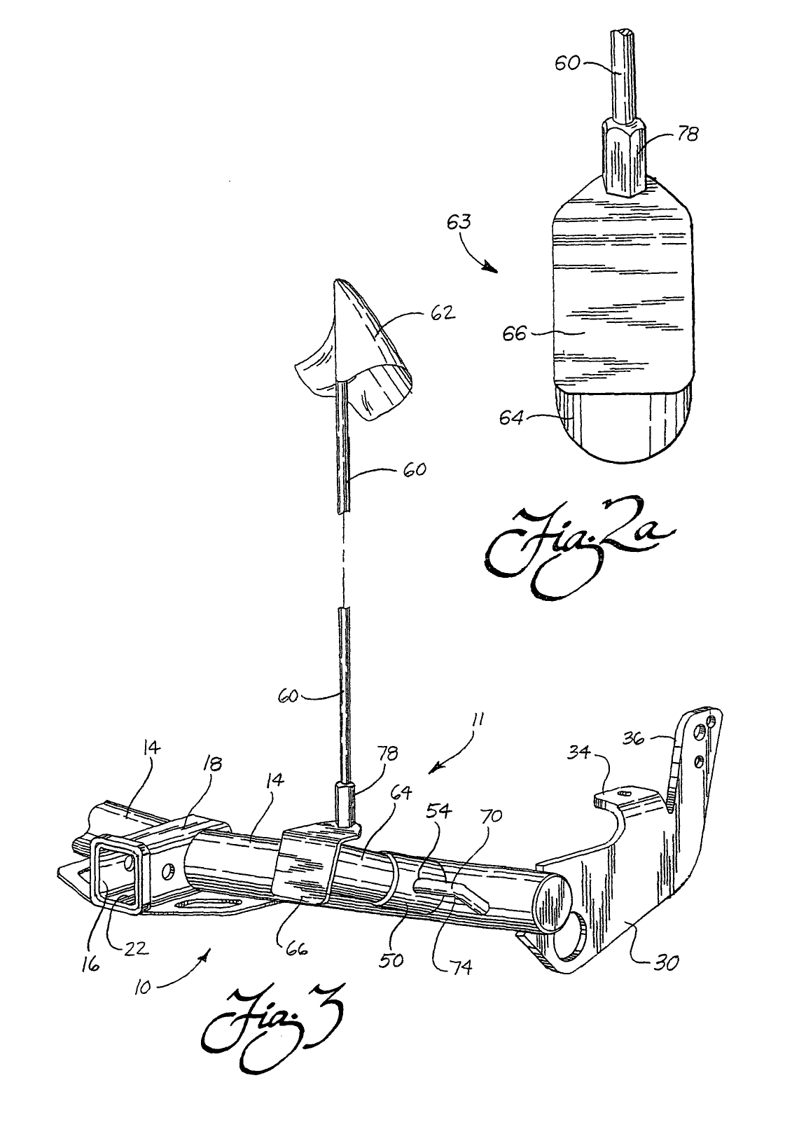

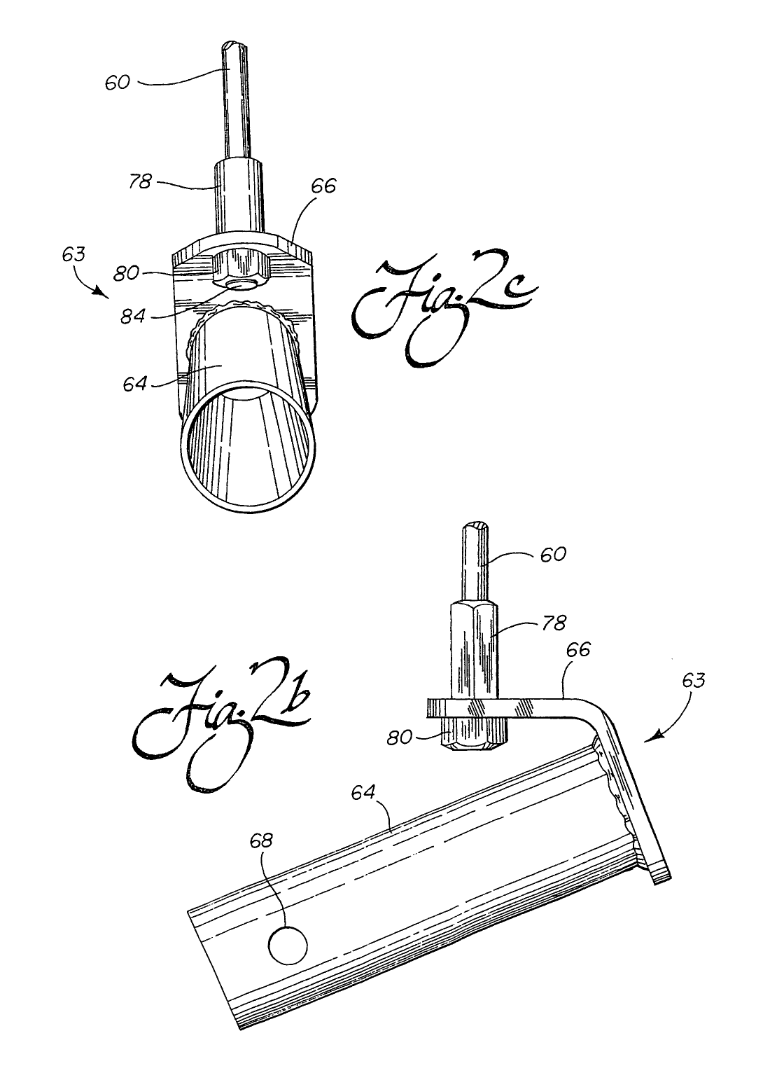

As best shown in FIGS. 2a-2c, the flag holding apparatus 11 of the present invention includes a pole 60 for receiving and carrying a flag, pennant or like device 62. The pole 60 may be formed from fiberglass, wood, plastic, aluminum or other appropriate material. The flag holding apparatus 11 includes a body 63, preferably constructed from aluminum, plastic or steel, having a bar 64 for securing the body in an accessory receiver 50 of the receiver assembly 10 and a mount 66 for receiving and holding the pole 60. As shown, the bar 64 has a circular cross section which is concentrically received and snugly fits within the port 52 of the accessory receiver 50. A pair of aligned mounting apertures 68 are provided at opposed sides of the bar 64. When the bar 64 is properly inserted in the accessory receiver 50 the mounting apertures 68 in the bar are aligned with the cooperating apertures 54 in the sidewall of the accessory receiver 50. A pin 70 of a type known in the art is then inserted through the aligned apertures 54, 68 and a cooperating pin clip (not shown) is utilized to secure the pin in position and complete the connection (see also FIG. 3). More specifically, the pin 70 includes a bend 74 at one end and a pin clip receiving groove adjacent the opposite end. Together, the bend 74 and pin clip prevent the pin 70 from being inadvertently removed from the aligned apertures 54 and 68 in the receiver 50 and bar 64 respectively so as to complete a secure and positive connection.

The flag pole 60 is secured to the mount 66 by means of a fastener such as cooperating sleeve 78 and lock nut 80. More specifically, the sleeve 78 includes a socket for receiving and holding the proximal end of the flag pole 60. The connection may be completed by threads, friction fit, appropriate adhesive or any other means known in the art suitable for the intended purpose. The sleeve 78 includes a threaded end 84 which is received in and passes through an aperture in the mount 66. The lock nut 80 is tightened on the threaded end 84 so that the mount 66 is clamped between the lock nut 80 and the sleeve 78. As shown in drawing FIGS. 2a-2c and 3, the outer wall of the sleeve 78 may be formed in a hexagonal, nut shape to allow engagement with a wrench. This aids in the tightening of the lock nut 80 thereby allowing the completion of a secure and positive connection between the flag pole 60 and the mount 66. Of course, substantially any form of fastener other than the sleeve 78 and nut 80 may be used so long as that fastener performs the intended function.

As best shown in drawing FIG. 2b, the mount 66 may take the form of a flange which projects upwardly from the bar 64 and forms an included angle with the bar of between substantially 10° to substantially 70°. This provides the flag holding apparatus 11 with a swept, aerodynamic look which enhances user satisfaction.

The foregoing description of the preferred embodiment of this invention has been presented for purposes of illustration and description. It is not intended to be exhaustive or to limit the invention to the precise form disclosed. Obvious modifications or variations are possible in light of the above teachings. For example, the bar 64 could be sized and shaped to be received in the receiver box 18 if desired. Substantially any shaped bar 64 could be used and it could be hollow as shown or solid so long as it allows attachment to the receiver assembly 10. Further, it should be appreciated that the apparatus 11 may be mounted to a receiver assembly 10 that does not include a receiver box 18 but, instead, just one or more accessory receivers 50.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

In the claims:

1. An apparatus for mounting a flag to a receiver assembly on a towing vehicle, comprising:
a pole for receiving and carrying the flag;
a body including a bar for securing said body to the receiver assembly and a mount for receiving and holding said pole; and
a fastener for securing said pole to said mount.

2. The apparatus set forth in claim 1 further including a pin and a pair of aligned mounting apertures in said bar for receiving and holding said pin that secures said apparatus to the receiver assembly.

3. The apparatus set forth in claim 2, further including an opening in said mount for receiving and holding said pole.

4. The apparatus set forth in claim 3, wherein a sleeve is carried on a proximal end of said pole and said fastener comprises a cooperating lock nut received on a threaded end of said sleeve for clamping said pole to said mount.

5. The apparatus set forth in claim 1, wherein a sleeve is carried on a proximal end of said pole and said fastener comprises a cooperating lock nut received on a threaded end of said sleeve for clamping said pole to said mount.

6. The apparatus set forth in claim 4, wherein said mount is a flange projecting upwardly from said bar at an included angle of between about 10° and about 70°.
